(19) United States
(12) Patent Application Publication
(10) Pub. No.: US 2009/0019325 A1
(43) Pub. Date: Jan. 15, 2009

(54) MEMORY DEVICE, SUPPORTING METHOD FOR ERROR CORRECTION THEREOF, SUPPORTING PROGRAM THEREOF, MEMORY CARD, CIRCUIT BOARD AND ELECTRONIC APPARATUS

(75) Inventors: Toshihiro MIYAMOTO, Kawasaki (JP); Akio TAKIGAMI, Kawasaki (JP); Masaya INOKO, Kawasaki (JP); Takayoshi SUZUKI, Kawasaki (JP); Hiroyuki ONO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/241,955

(22) Filed: Sep. 30, 2008

Related U.S. Application Data
(63) Continuation of application No. PCT/JP2006/306893, filed on Mar. 31, 2006.

(51) Int. Cl. G06F 11/00

(52) U.S. Cl. 714/702; 714/701; 714/E11.002

(57) ABSTRACT

A memory device (memory module) having one or a plurality of memory chips is disclosed. By including in a memory chip an error generation part to generate an error, an error is generated in a specific area of a memory in accordance with an address specification, thereby confirmation of an ECC function is facilitated. The error generation part includes an error code generation part that generates an error code. The memory chip is configured by one or a plurality of memory matrixes.

### CROSS-REFERENCE TO RELATED APPLICATIONS

This application is a continuation of International Application No. PCT/JP2006/306893, filed on Mar. 31, 2006, now pending, herein incorporated by reference.

### BACKGROUND OF THE INVENTION

1. Field of the Invention

The present invention relates to a memory device used for storing information in an electronic apparatus such as a personal computer (PC). More particularly, the present invention relates to a memory device generating an error correction code in a memory, a supporting method for error correction thereof, a supporting program thereof, a memory card, a circuit board and an electronic apparatus.

2. Description of the Related Art

In a PC, used is a memory such as an SDRAM (Synchronous Dynamic Random Access Memory) specified by a JEDEC (Joint Electron Device Engineering Council) and a DDR-SDRAM (Double Data Rate-SDRAM).

Concerning such memory, Japanese Patent Application Laid-Open Publication No. 2004-110785 A (Abstract, FIG. 1, etc.) describes a memory controller including a plurality of programmable timing registers programmable so as to store timing information suitable to a memory device. Japanese Patent Application Laid-Open Publication No. H6-208515 A (Abstract, FIG. 1, etc.) describes a memory card containing a microprocessor chip and a nonvolatile memory chip that are connected by an internal card bus, the microprocessor chip including key information, information on use and program instruction information. Japanese Patent Application Laid-Open Publication No. H9-6722 A (Abstract, FIG. 2, etc.) describes a computer system whose I/O processors include an embedded processor combined with a local memory. Japanese Patent Application Laid-Open Publication No. 2005-196486 A (paragraph No. 0029, FIG. 6, etc.) describes a memory including a storing means along with an SPI driver inside. Published Japanese translation of PCT international application No. H9-507325 A (Abstract, FIG. 1, etc.) describes a data processing system including a CPU that is linked to a data memory via an unidirectional reading bus, au unidirectional writing bus and an address bus. Japanese Patent Application Laid-Open Publication No. 2002-63791 A (Abstract, FIG. 1, etc.) describes a memory system wherein a bus transferring write-in data is arranged separately from a bus transferring read-out data, and a memory controller and a memory are connected. Japanese Patent Application Laid-Open Publication No. H11-328975 A (Abstract, FIG. 2, etc.) describes a random access memory which controls data transference operation to the memory in response with a first transition of period signal, wherein data transference operation from random access memory array is controlled in response with a second transition of period signal. Japanese Patent Application Laid-Open Publication No. H7-169271 A (paragraph No. 0038, FIG. 1, etc.) describes a semiconductor storage device including a CDRAM that has a DRAM control and cache/refresh control unit along with a DRAM unit. Japanese Patent Application Laid-Open Publication No. H8-124380 A (paragraph No. 0020, FIG. 2, etc.) describes a synchronous DRAM including memory array and a control unit, the synchronous DRAM enabling a mode register to be set only when contents of a data bus and operation state confirmation information are equal. Japanese Patent Application Laid-Open Publication No. H9-259582 A (paragraph No. 0028, FIG. 1, etc.) describes a mode register control circuit such as an SDRAM.

There is an ECC (Error Correcting Code) checking function as a function for correcting and detecting data error in a memory. A method is executed that a certain bit of a data bus of a memory is fixed to “0” or “1” by a switch in order to check whether a computer having such function operates normally.

For example, as shown in FIG. 1, a mechanical switch 10 is intervened in a data bus 8 that is connected via an interface 6 between a chip set 2 and a memory module 4. A point “a” of the switch 10 is connected to a voltage VCC and fixed to “1”, a point “b” is “normal” and a point “c” is grounded and fixed to “0”. The ECC checking function is confirmed by switching a movable point d to “1” or “0”. In this case, once being fixed to “1” or “0”, all addresses become an error and a particular address cannot be specified.

From the above, if two memory modules are used, it is necessary that data and a test program are respectively assigned to slot where each memory module is attached. It is also necessary for confirming whether both slots are in parity or alive that data 13 and a test program 14 are changed with each other toward slots 11 and 12 as shown in FIGS. 2A and 2B. In this case, a dot line 15 depicts a test object.

In processing procedure of a confirmation process of the ECC checking function, as shown in FIG. 3, the switch 10 is operated to generate an error (step S1). In this case, while a certain bit of the data bus 8 is fixed to 0 or 1, an error generation address is not specified in this process. After the generation of the error, the test program 14 is started up (step S2) and error correction and error detection are determined (step S3). This determination is a process for checking whether the error is corrected or not and the error is rightly detected or not. As a result of the determination, a determination result of normal (step S4) or an anomaly (step S5) is obtained and the process is ended. In this case, in starting up of the test program 14 in step S2, a data writing process (step S11) and a data reading process (step S12) are executed and the process is returned to step S2 as shown in FIG. 4.

Since a high technique is required for such process, confirmation cannot be done under an environment of an OS (Operating System) using a virtual storage system. The reason thereof is that in the OS using a virtual storage, since a memory address is different from an address on a program, it depends on the OS which area a program itself checking the ECC function is allocated to, so as to be allocated to a memory (a memory module and so on) that is a checked object in the OS itself necessary for the checking program and operation thereof.

If the ECC function is tried to be checked in case the checking program and the OS itself are in a memory that is an object to be checked, all the system may be runaway when an error correction function does not operate normally. In the virtual storage system, all system being made runaway may cause the OS to be disabled. If the system is runaway, operation when an error is generated cannot be confirmed.

If operation of error generation of two bits or over is tried to be confirmed, an error of two bits or over occurs in data toward every address, and miss-operation is generated in the checking program and the OS itself to cause the system to be runaway.

Generally, it is difficult to suppose that an error occurs simultaneously to all of the addresses. Even if an error is within one bit thus correctable, the system may be runaway according to an ECC circuit. An error may not be evaluated, because the error is asynchronous with a memory clock or occurred is an unexpected signal state such as data change including chattering by generating an error with manual operation.

From the above, in the conventional EEC function check, it is executed that a DOS (Disc Operating System) not using virtual storage is used for determining an address of a program by the checking program itself. In this case, as shown in FIG. 2, a memory storing the checking program and a memory of a checked object are separate. The reason why the ECC checked object is separated physically into data and the checking program is, since right data cannot be read/written if a certain bit of a memory is shorted to 0 or 1, to avoid impossibility of execution of a program written simultaneously in the memory to be runaway if the error correction function is not sufficient or an error of two bits and more that is uncorrectable occurs even if the error can be generated. For avoiding such runaway, it is necessary to confirm that an error is normally processed by accessing a test object memory with a test program, such that the program and a test object memory chip are separately arranged by intent in order not to include the program in a shorted memory by devising arrangement of the program. Such a process is limited to such that a used OS does not use virtual storage, and, high technique is required on creation of a hardware and the checking program.

Concerning such ECC checking, the conventional interface has only a bit of the ECC. The request for support of the ECC is that it can be checked without specific workmanship externally and in operational environment whether the ECC function itself functions normally. When a memory chip is minimized and an interface is speeded up, it is difficult for the conventional method where some circuit is externally attached to a pattern to confirm the ECC function because inherent operation is destabilized.

Because the conventional method needs workmanship toward program arrangement and such arrangement includes the OS, the OS like the DOS is needed as described above. Therefore, it is very difficult for the conventional interface to check the ECC function under the environment of the known OS.

Concerning such problems, there is no suggestion or disclosure thereof in any of the above patent documents, and no disclosure about solving means therefor is presented.

### SUMMARY OF THE INVENTION

An object of the present invention relates to a memory device including one or a plurality of memory chips and is to facilitate confirmation of an ECC function.

An object thereof relates to a memory device including one or a plurality of memory chips and is to enhance accuracy of confirmation of an ECC function.

In order to achieve the above objects, the present invention is a memory device including one or a plurality of memory chips and by including an error generation part that generates an error in the memory chip, an error is generated in a specific area in the memory device with address specification to the memory device and an error check function is confirmed.

In order to achieve the above objects, according to a first aspect of the present invention there is provided a memory device having one or a plurality of memory chips, comprising an error generation part, which generates an error, being provided in the memory chip. According to such structure, an error can be generated in the memory chip by the error generation part disposed in the memory chip to facilitate confirmation of an error checking function and to enhance checking accuracy.

In order to achieve the above objects, in the above memory device, preferably the error generation part may include an error code generation part that generates an error code. According to such structure, an error code can be generated from the error generation part disposed in the memory chip. This error code can be supplied to an error generation area in the memory chip. Thus, the above objects can be achieved.

In order to achieve the above objects, in the above memory device, preferably the memory chip may include one or a plurality of memory matrixes. According to such structure, the above objects can be achieved.

In order to achieve the above objects, in the above memory device, preferably the error code generation part may be connected to a memory matrix of the memory chip via a column decoder. According to such structure, the above objects can be achieved.

In order to achieve the above objects, according to a second aspect of the present invention there is provided a supporting method for correcting an error of a memory device having one or a plurality of memory chips, the method comprising the steps of securing a data area where an error is generated in the memory chip; and giving an error code toward the data area from an error code generation part in the memory chip. According to such structure, the above objects can be achieved.

In order to achieve the above objects, preferably the above supporting method may further comprise the step of recognizing an address in the data area. According to such structure, the above objects can be achieved.

In order to achieve the above objects, preferably the above supporting method may further comprise the step of specifying an address and/or a bit condition which generate an error to the memory chip. According to such structure, the above objects can be achieved.

In order to achieve the above objects, preferably the above supporting method may further comprise the step of executing writing or reading of the data. According to such structure, the above objects can be achieved.

In order to achieve the above objects, preferably the above supporting method may further comprise the step of determining whether error correction is normal. According to such structure, the above objects can be achieved.

In order to achieve the above objects, according to a third aspect of the present invention there is provided a supporting program of correcting an error of a memory device having one or a plurality of memory chips, the program comprising the steps of securing a data area where an error is generated in the memory chip; and giving an error code toward the data area from an error code generation part in the memory chip. According to such structure, the above objects can be achieved.

In order to achieve the above objects, preferably the above supporting program may further comprise the step of recognizing an address in the data area. According to such structure, the above objects can be achieved.

In order to achieve the above objects, preferably the above supporting program may further comprise the step of specifying an address and/or a bit condition which generate an error to the memory chip. According to such structure, the above objects can be achieved.

In order to achieve the above objects, preferably the above supporting program may further comprise the step of executing writing or reading of the data. According to such structure, the above objects can be achieved.

In order to achieve the above objects, preferably the above supporting program may further comprise the step of determining whether error correction is normal. According to such structure, the above objects can be achieved.

In order to achieve the above objects, according to a fourth aspect of the present invention there is provided a memory card having one or a plurality of memory chips, comprising an error generation part, which generates an error, being provided in the memory chip. According to such structure, the above objects can be achieved.

In order to achieve the above objects, in the above memory card, preferably the error generation part may include an error code generation part that generates an error code. According to such structure, the above objects can be achieved.

In order to achieve the above objects, in the above memory card, preferably the memory chip may include one or a plurality of memory matrixes. According to such structure, the above objects can be achieved.

In order to achieve the above objects, in the above memory card, preferably the error code generation part may be connected to a memory matrix of the memory chip via a column decoder. According to such structure, the above objects can be achieved.

In order to achieve the above objects, according to a fifth aspect of the present invention there is provided a circuit board where a memory card having one or a plurality of memory chips is mounted, comprising an error generation part, which generates an error, being provided in the memory chip. According to such structure, the above objects can be achieved.

In order to achieve the above objects, in the above circuit board, preferably the error generation part may include an error code generation part that generates an error code. According to such structure, the above objects can be achieved.

In order to achieve the above objects, in the above circuit board, preferably a storing part storing an error confirmation processing program may be mounted. According to such structure, the above objects can be achieved.

In order to achieve the above objects, according to a sixth aspect of the present invention there is provided an electronic apparatus wherein the above memory device is used. This electronic apparatus has only to be an apparatus storing information by using a memory device such as a computer apparatus. According to such structure, the above objects can be achieved.

In order to achieve the above objects, according to a seventh aspect of the present invention there is provided an electronic apparatus wherein the above memory card is used. Also in this case, this electronic apparatus has only to be an apparatus storing information by using a memory device such as a computer apparatus. According to such structure, the above objects can be achieved.

In order to achieve the above objects, according to an eighth aspect of the present invention there is provided an electronic apparatus wherein the above circuit board is used. Also in this case, this electronic apparatus may be a thing storing information by using a memory device such as a computer apparatus. According to such structure, the above objects can be achieved.

Features and advantages of the present invention are listed as follows.

(1) An ECC function can be confirmed by generating an error from an error generation part disposed in a memory chip. Facilitation of confirmation of the ECC function and improvement of confirmation accuracy are attempted.

(2) An ECC function can be confirmed by generating an error code from an error code generation part disposed in a memory chip. Facilitation of confirmation of the ECC function can be attempted.

(3) An ECC function can be confirmed by generating an error code from an error code generation part disposed in a memory chip. Accuracy of confirmation of the ECC function can be enhanced.

Other objects, features and advantages of the present invention are more clearly understood by referring to the attached drawings and each of the embodiments.

### BRIEF DESCRIPTION OF THE DRAWINGS

FIG. 1 depicts an error generation circuit for confirming an ECC checking function of a conventional memory;

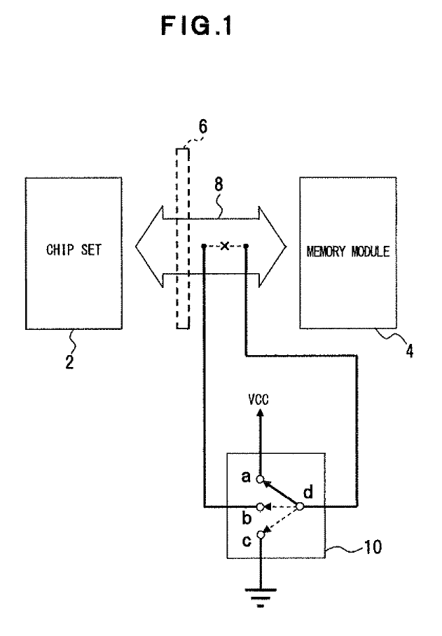

FIGS. 2A and 2B depict a method for confirming the ECC checking function of the conventional memory;

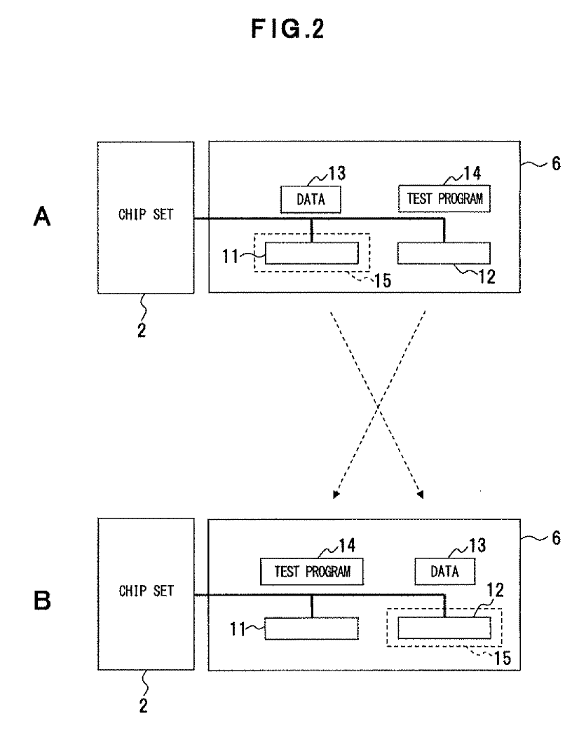

FIG. 3 is a flowchart showing processing procedure of confirmation of the ECC checking function of the conventional memory;

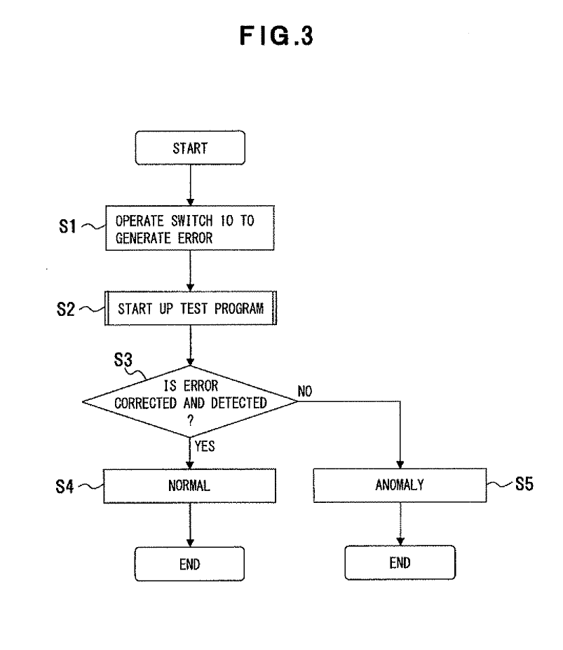

FIG. 4 is a flowchart showing processing procedure of a test program;

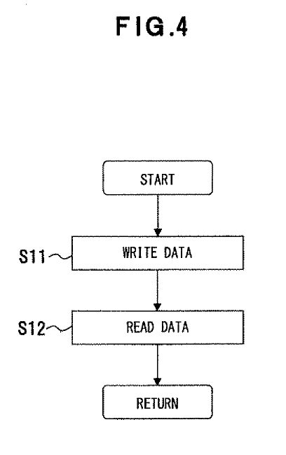

FIG. 5 depicts a structural example of a memory module according to a first embodiment;

FIG. 6 depicts a structural example of a memory chip;

FIGS. 7A to 7F are timing charts showing input/output control of a control register;

FIG. 8 depicts a structural example of a personal computer according to a second embodiment;

FIG. 9 is a flowchart showing processing procedure of a confirmation process of an ECC checking function;

FIG. 10 depicts a structural example of a memory card according to a third embodiment; and

FIG. 11 depicts a structural example of a circuit board according to a fourth embodiment.

### DETAILED DESCRIPTION OF THE PREFERRED EMBODIMENTS

### First Embodiment

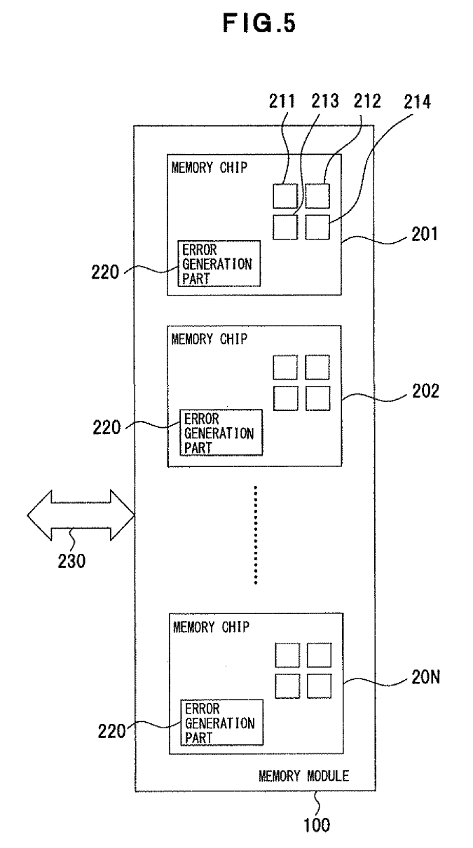

A first embodiment of the present invention will now be described with reference to FIG. 5. FIG. 5 depicts a structural example of a memory module according to the first embodiment. FIG. 5 is one example of a memory device of the present invention, and the present invention is not limited to the structure shown in FIG. 5.

A memory module 100 is one example of a memory device according to the present invention. For example, a plurality of memory chips 201, 202 . . . 20N are mounted on a circuit board. Each of the memory chips 201, 202 . . . 20N is structural unit constituting a memory. The memory chip is not required to be a minimum structural unit. Different structure may be used. While the memory module 100 is constituted of a plurality of memory chips 201, 202 . . . 20N, the embodiment may be constituted of one memory module.

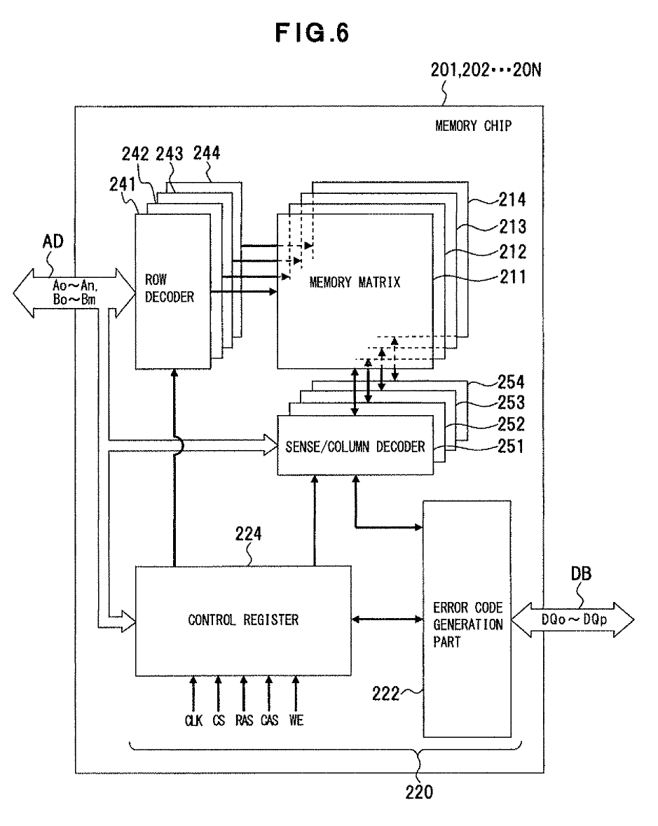

In this case, in each memory chip 201, 202 . . . 20N, for example, four pairs of memory matrixes 211, 212, 213 and 214 are located as a plurality of banks and a control register 224 (FIG. 6) is also located as a storage part storing control information. In each control register 224, control information of each memory chip 201, 202 . . . 20N is individually stored. In this control information, for example, CAS (Column Array Strobe) latency, burst length, additive latency, etc. are included as a various parameters about a memory. That is, control information may be different by each memory chip 201, 202 . . . 20N or may be the same.

In the memory module 100, an error generation part 220 is located as an error generating function part that generates a quasi-error for checking an ECC function. The error generation part 220, for example, generates an error code and enables confirmation of the ECC checking function.

A bus 230 is connected to each memory chip 201, 202 . . . 20N. Data can be read and written toward the memory chips 201-20N specified by address information.

From such structure, an error is generated individually from the error generation part 220 that is mounted on each of the memory chips 201-20N to each memory chip 201-20N. The ECC checking function can be confirmed without supply of an error code from an outside.

The memory chips 201-20N located on the memory module 100 will now be described with reference to FIG. 6. FIG. 6 is a block diagram showing a structural example of a memory chip. In FIG. 6, the same components as described in FIG. 5 are denoted by the same reference numerals.

In each memory chip 201-20N, a plurality of memory matrixes 211-214 are located, and row decoders 241, 242, 243 and 244, and sense/column decoders 251, 252, 253 and 254 corresponding to each of the memory matrixes 211-214 are located. In each memory matrix 211-214, a plurality of memory cells are arranged in a form of a matrix, that is, in a plurality of rows and columns. In this case, an address signal of N bits enters into the row decoders 241-244 by a row address selection signal RAS via a row buffer of N bits, and memory cells of one row is selected. An address signal of N bits also enters into the sense/column decoders 251-254 by a column address selection signal CAS, a column thereof is selected and data can be read and written. Such operation is possible by each of memory matrixes 211-214. In this case, to the row decoders 241-244, writing addresses Ao-An and bank addresses Bo-Bm are added via an address bus AB. From an error code generation part 222, data DQo-DQp is outputted to a data bus DB.

The error code generation part 222 that generates an error code necessary for ECC checking is included in the error generation part 220. The data bus DB is connected to the error code generation part 222. The error code generation part 222 generates an error code by an access from an outside device. To the error code generation part 222, the control register 224 is connected as a storing means. To the control register 224, an error code generated by the error code generation part 222 is added. In this case, to the control register 224, a bit that specifies an error generated address, a generation bit and a generating mode is set. The error code generation part 222 configures a data input circuit, and is used for inputting and outputting data from/to an outside via the data bus DB.

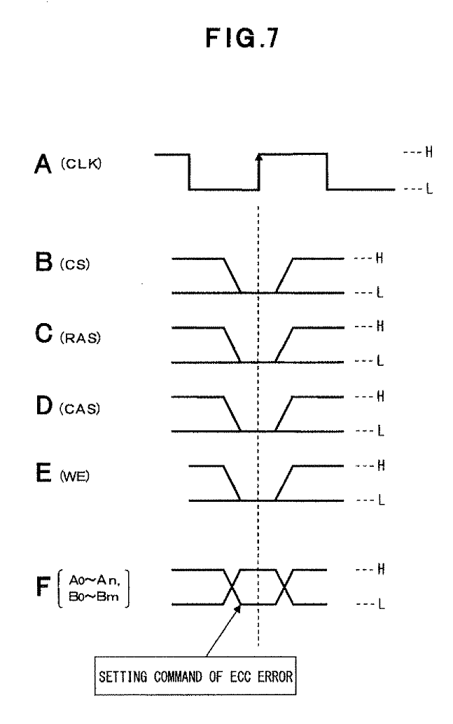

In such structure, to the control register 224, as shown in FIG. 7, added are a clock signal CLK (A in FIG. 7), a chip selection signal CS (B in FIG. 7), a row address selection signal RAS (C in FIG. 7), a column address selection signal CAS (D in FIG. 7), a write enabling signal WE (E in FIG. 7) and address information Ao-An and Bo-Bm as a read command (F in FIG. 7). By receiving such command signals, output data including a quasi-error can be obtained from the error code generation part 222.

An error can be generated to a specific area by an error code generated from the error code generation part 222 to the control register 224 of each memory chip 201-20N only if the specific area of the memory module 100 is accessed.

### Second Embodiment

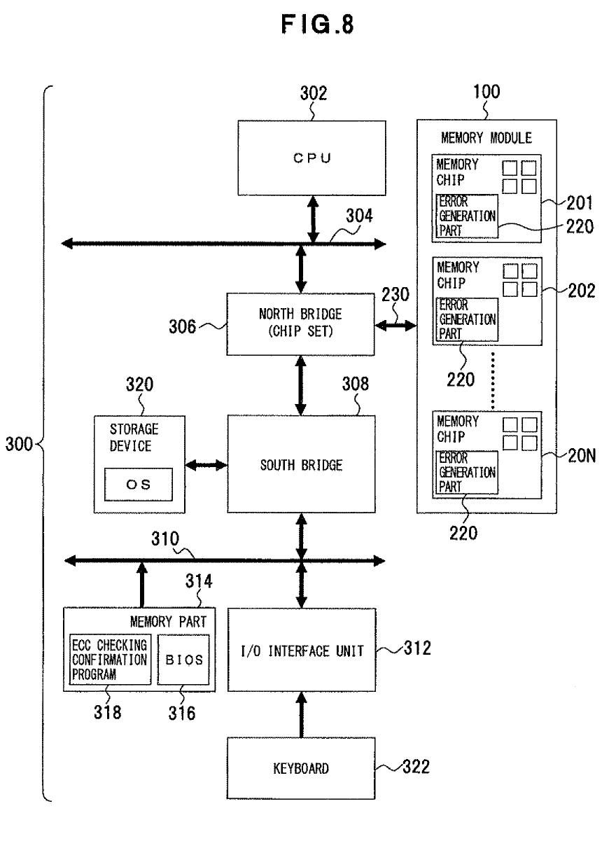

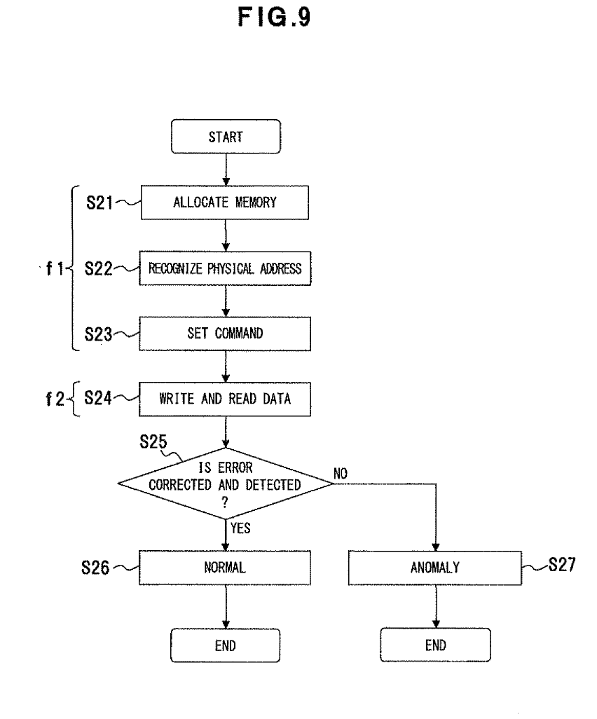

A second embodiment of the present invention will now be described with reference to FIGS. 8 and 9. FIG. 8 depicts a structural example of a personal computer (PC) according to the second embodiment. FIG. 9 is a flowchart showing processing procedure of a confirmation process of an ECC checking function. In FIG. 8, the same components as described in FIG. 5 or 6 are denoted by the same reference numerals.

This PC 300 is one example of an electronic apparatus including a memory module 100. The PC 300 is configured to enable reading and writing of storing information of each control register 224 (FIG. 6) in memory chips 201-20N of the memory module 100 on the busis of address information.

In the PC 300, a CPU (Central Processing Unit) 302 is located. To the CPU 302, a north bridge (chip set) 306 is connected via a bus 304. To the north bridge 306C the memory module 100 is connected and an I/O interface unit 312 is also connected via a south bridge 308 and a bus 310. The north bridge 306 is a means for passing data between the CPU 302 and the memory module 100. The south bridge 308 is a means for passing data between the CPU 302 and the I/O interface unit 312.

Since the memory module 100 has the structure described above (FIGS. 5 and 6), the same components are denoted and description thereof is omitted.

To the bus 310, a memory part 314 constituted by a non-volatile memory and so on is connected. The memory part 314 stores a BIOS (Basic Input/output System) 316 and an ECC checking confirmation program 318 for confirming the ECC checking function of the memory module 100. The ECC checking confirmation program 318 may be executed by an operation system (OS) stored in a storing device 320 that is constituted by a non-volatile memory like a hard disc device, and by other programs. To the I/O interface unit 312, for example, a keyboard 322 and a not shown display are connected as an input/output device.

In such structure, a confirmation process of the ECC checking function will be described with reference to FIG. 9. In this process, a preparing process f1 and an actual behaving process f2 of a data access are included. That is, if allocation of a memory is generated (step S21), a data area for generating an error is secured. In this case, for example, memory matrixes 211-214 are designated.

After the allocation, a physical address is recognized (step S22) and a physical address of a data area is recognized. In this case, the memory matrixes 211-214 and memory chips 201-20N are to be designated.

A command is set (step S23) and conditions of an error generation address and a generation bit are designated to the memory chips 201-20N. These processes of steps S21-S23 are the preparing process f1.

After such preparing process f1, data is read and written (step S24). It is determined whether an error is normally corrected and detected (step S25), and normal (step S26) or an anomaly (step S27) is outputted as a result of the determination.

Like the above, the error code generation part 222 is located on the memory chips 201-20N. Thus, ECC checking of the memory matrixes 211-214 designated as an address via the control register 224 can be confirmed, and confirmation of the ECC checking is facilitated and high accuracy thereof is achieved.

### Third Embodiment

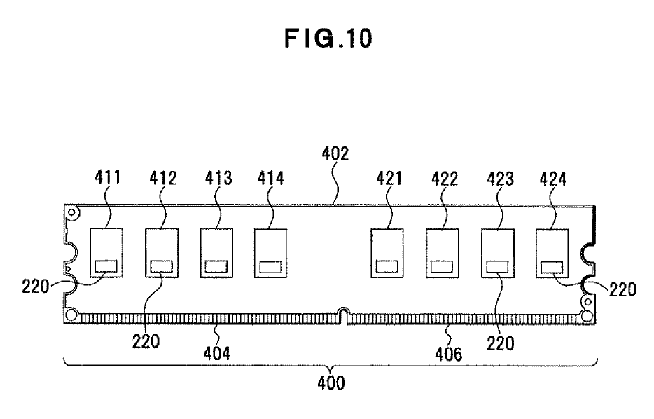

A third embodiment of the present invention will now be described with reference to FIG. 10. FIG. 10 depicts a structural example of a memory card according to a third embodiment. In FIG. 10, the same components as described in FIG. 5 or 6 are denoted by the same reference numerals.

This memory card 400 is a concrete embodiment of the above described memory module 100 (FIG. 5). In a circuit board 402, connecters 404 and 406 that achieve electrical connection by inserting a socket on a motherboard side are formed. On the connecter 404 side, mounted are four pairs of memory chips 411, 412, 413 and 414, and on the connecter 406 side, mounted are four pairs of memory chips 421, 422, 423 and 424. On each memory chip 411-414 and 421-424, memory matrixes 211-214 and the error code generation part 222 are mounted as described.

According to such structure, since the error code generation part 222 and the control register 224 (FIG. 6) are included in the memory chips 411, 412, 413, 414, 421, 422, 423 and 424 as described above, an error code can be generated, an ECC checking function can be confirmed, a process thereof is facilitated and accuracy thereof is improved.

### Fourth Embodiment

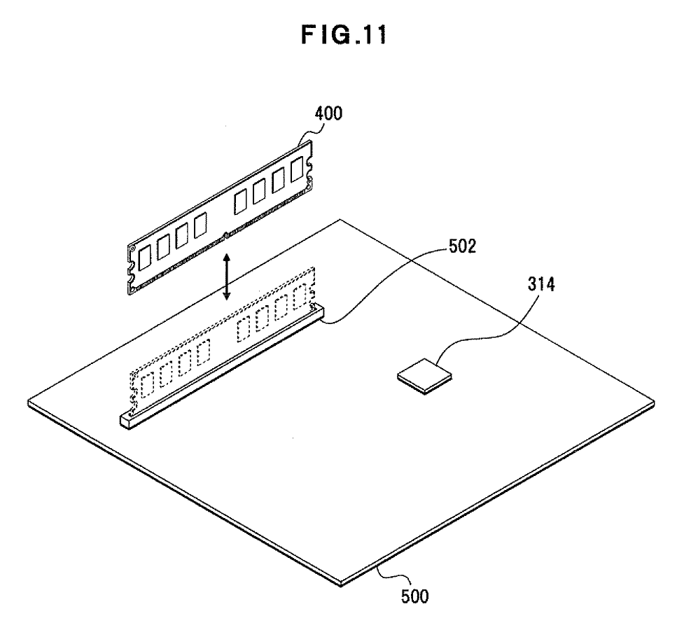

A fourth embodiment of the present invention will now be described with reference to FIG. 11. FIG. 11 depicts a structural example of a circuit board according to a fourth embodiment. In FIG. 11, the same components as described in FIGS. 5, 6 and 8 are denoted by the same reference numerals.

On this circuit board 500, mounted are a memory slot 502 for attaching the memory card 400 (FIG. 10) where the above described memory module 100 is mounted (FIG. 5), and the memory part 314 (FIG. 8) storing the ECC checking confirmation program 318. The memory slot 502 and the memory part 314 are connected via a north bridge 306, a south bridge 308, a bus 310, etc.

According to such circuit board 500, the ECC checking confirmation program 318 is started up, an error code is generated from the error code generation part 222 of the memory card 400 attached to the memory slot 502 and the ECC checking confirmation can be processed.

### Other Embodiments

The following are examples of modification and features, etc. of the above embodiments.

(1) A determination function by a program can be held by a control register 224 of memory chips 202-20N. In this case, if interface timing is different depending on generations, an interface for control may be held separately and recognition may be done by the interface for control.

(2) In the above embodiment, the PC 300 is exemplified as an electronic apparatus applicable to the memory device. The present invention can be broadly used in a television set that have a PC function, a server, a telephone, etc.

(3) In the above embodiment, structure is described that the error code generation part 222 disposed in the error generation part 220 is also used as an input and output circuit of data. The input and output circuit of data and the error code generation part 222 may be configured separately. The present invention is not limited to the above described structure.

While the most preferred embodiments of the present invention have been described hereinabove, the present invention is not limited to the above embodiments, and it is a matter of course that various variations and modifications can be made by those skilled in the art within the scope of the claims without departing from the spirit of the invention disclosed herein, and needless to say, such variations and modifications are also encompassed in the scope of the present invention.

The present invention includes an error generation part within a memory chip. Since structure is made that an error is generated in the memory chip, an error checking function can be confirmed by a memory chip, confirmation of an error checking function is facilitated and high accuracy thereof is achieved. Thus, the present invention is useful.

What is claimed is:

1. A memory device having one or a plurality of memory chips, comprising:
an error generation part, which generates an error, being provided in the memory chip.

2. The memory device of claim 1, wherein the error generation part includes an error code generation part that generates an error code.

3. The memory device of claim 1, wherein the memory chip includes one or a plurality of memory matrixes.

4. The memory device of claim 2, wherein the error code generation part is connected to a memory matrix of the memory chip via a column decoder.

5. A supporting method for correcting an error of a memory device having one or a plurality of memory chips, the method comprising the steps of:
securing a data area where an error is generated in the memory chip; and
giving an error code toward the data area from an error code generation part in the memory chip.

6. The supporting method of claim 5, further comprising the step of recognizing an address in the data area.

7. The supporting method of claim 5, further comprising the step of specifying an address and/or a bit condition which generate an error to the memory chip.

8. The supporting method of claim 5, further comprising the step of executing writing or reading of the data.

9. The supporting method of claim 5, further comprising the step of determining whether error correction is normal.

10. A memory card having one or a plurality of memory chips, comprising:
an error generation part, which generates an error, being provided in the memory chip.

11. The memory card of claim 10, wherein the error generation part includes an error code generation part that generates an error code.

12. The memory card of claim 10, wherein the memory chip includes one or a plurality of memory matrixes.

13. The memory card of claim 10, wherein the error code generation part is connected to a memory matrix of the memory chip via a column decoder.

14. A circuit board where a memory card having one or a plurality of memory chips is mounted, comprising:
an error generation part, which generates an error, being provided in the memory chip.

15. The circuit board of claim 14, wherein the error generation part includes an error code generation part that generates an error code.

16. The circuit board of claim 14, wherein a storing part storing an error confirmation processing program is mounted.

17. An electronic apparatus wherein the memory device of claim 1 is used.

18. An electronic apparatus wherein the memory card of claim 10 is used.

19. An electronic apparatus wherein the circuit board of claim 14 is used.
